(19) United States
(12) Patent Application Publication
(10) Pub. No.: US 2025/0334947 A1
(43) Pub. Date: Oct. 30, 2025

(54) METHOD OF MONITORING A PAPER PROCESS AND APPARATUS

(71) Applicant: ABB Schweiz AG, Baden (CH)

(72) Inventors: Jan-Christoph Schlake, Darmstadt (DE); Katharina Stark, Weinheim (DE); Thorsten Schindler, Schriesheim (DE); Marco Ulrich, Großniedesheim (DE)

(21) Appl. No.: 18/855,362

(22) PCT Filed: Apr. 11, 2022
(86) PCT No.: PCT/EP2022/059623

§ 371 Date: Oct. 9, 2024

(51) Int. Cl. G05B 19/401

(52) U.S. Cl. CPC G05B 19/401; G05B 2219/37537

(57) ABSTRACT

A quality estimation system comprises a process model specific for at least a portion of the paper production process and including material portion representors being virtual representations of material portions within the continuous flow of material being processed. Each of the representors comprises at least one quality attribute for the respective material portion. Monitoring the process comprises determining, using a sensor, measured quantities of the material being processed and associating respective time stamps with the measured quantities. The monitoring further comprises determining, for each of the measured quantities with the time stamps, an associated material portion, and an associated position within the associated material portion. The monitoring further comprises, determining, for a selected material portion, the at least one quality attribute based on the measured quantities to which the selected portion is associated and on the associated position within the selected portion, and outputting the at least one quality attribute.

### CROSS-REFERENCE TO RELATED APPLICATIONS

The present application is a national phase entry of International Patent Application No. PCT/EP2022/059623, filed on Apr. 11, 2022, and titled “Method of monitoring a paper process and apparatus”, which is hereby incorporated by reference in its entirety.

### TECHNICAL FIELD

The present disclosure relates to paper production in the field of pulp and paper (P&P) industry. Embodiments relate to a method of monitoring a paper production process, and to a corresponding quality estimation system.

### BACKGROUND

The pulp and paper (P&P) industry is an energy-intensive industry, and it is therefore of interest to bring down the energy consumption. One important lever to reduce energy consumption per ton sellable product produced, and also to reduce production cost, is to produce less paper waste. During the fabrication process, the quality of the product is measured continuously using a Quality Control System (QCS).

The quality control system (QCS) is used in a paper machine to measure and control quality attributes of a paper continuously while it is running through the paper machine. Several measurement devices measure different quality attributes, e.g. Thickness, Caliper, Ash content, Color, Moisture, Basis weight, brightness, smoothness and gloss, coat weight, formation, porosity, fiber orientation and surface properties. The measurement devices are installed in one or various QCS scanner beams allowing to provide continuous measurements in machine direction (MD) or cross-machine direction (CD). For typical scanner beams, the measurement results are only available in a 1D sensor trajectory, namely in a linear combination of machine and cross-machine direction depending on machine and sensor speed. These measurement values can be provided to the Distributed Control System (DCS), allowing the operator to act in case of deviations from setpoint. The state-of-the-art setup is expensive and due to the size of the QCS, the setup allows to only measure at distinct locations where enough space for the setup is available.

In addition to this, laboratory samples can be taken to determine the paper quality more accurately and/or over a larger area of the paper product. This approach, however, has a delay of several minutes and does not allow to take immediate action. Also, video systems can be installed to continuously inspect the paper in 2D visually. These video systems, while useful, may not reveal information about all of the relevant quality attributes.

There is therefore a need for a more accurate, more timely and/or more complete information retrieval of process information about relevant process and quality attributes.

### BRIEF DESCRIPTION

It is an object of the present disclosure to reduce at least some of the problems outlined above, and in particular to allow obtaining more accurate, more timely and/or more complete information about relevant process and quality attributes.

In view of the above, a method of monitoring a paper production process using a quality estimation system is provided. The paper production process being a continuous process wherein a continuous flow of material is being processed. The quality estimation system comprises a process model specific for at least a portion of the paper production process and material portion representors being virtual representations in the process model of material portions within the continuous flow of material being processed. Each of the material portion representors comprises at least one quality attribute for the respective material portion. The method comprises: determining, using a sensor, a stream of measured quantities of the material being processed; associating respective time stamps with the measured quantities; determining, for each of the measured quantities and using the associated time stamps, respectively an associated material portion of the material portions, and an associated position within the associated material portion. The method further comprises determining, for a selected material portion of the material portions, the at least one quality attribute based on the measured quantities to which the selected material portion is associated and on the associated position within the selected material portion; and outputting the determined at least one quality attribute.

Thus, according to embodiments it becomes possible to run a process model for the material flow, wherein the material flow is represented by virtually discretized material portions, and thereby to determine quality attribute(s) of the material portions. Knowledge of these quality attribute(s) may, for example, enable optimizing energy consumption, resource consumption and/or CO2 emissions.

Further advantages, features, aspects and details that can be combined with embodiments described herein are evident from the dependent claims, claim combinations, the description and the drawings.

### BRIEF DESCRIPTION OF DRAWINGS

FIG. 1 is a schematic illustration of a quality estimation system according to aspects of the present disclosure;

FIG. 2 is a schematic illustration of a sensor trajectory of a sensor mounted on a QCS scanner beam;

FIG. 3 is a schematic illustration of 2D quality attributes spanning the cross machine direction;

FIG. 4a is a chart illustrating a method of training a machine-learning system for improving predictions;

FIG. 4b is a chart illustrating a method of predicting quality attributes using a machine-learning algorithm;

FIG. 5 is a chart illustrating a deviation between a simulation according to an embodiment, and a sensor reading; and

FIG. 6 is a network chart of a control structure for a paper production process according to an embodiment.

### DETAILED DESCRIPTION

Reference will now be made in detail to various aspects and embodiments, examples of which are illustrated in each figure. Each example is provided by way of explanation and is not meant as a limitation. For example, features illustrated or described as part of one embodiment or as one aspect can be used in conjunction with any other embodiment or aspect, e.g., to yield yet a further embodiment. It is intended that the present disclosure includes such modifications and variations.

Within the following description of the drawings, the same reference numbers refer to the same or to similar components. Generally, only the differences with respect to the individual embodiments are described. Unless specified otherwise, the description of a part or aspect in one embodiment can be applied to a corresponding part or aspect in another embodiment as well.

Within the following description relevant references are cited where appropriate to further promote understanding. The cited references are incorporated herein by reference.

Before describing the embodiments shown in the Figures, first some general aspects related to the present disclosure are described. The present disclosure provides methods of monitoring paper production processes using quality estimation systems. The solutions are based on running a process model for the material flow in the paper production process, wherein the material flow is represented by virtually discretized material portions of the material being processed. Such a process model is herein also referred to as a material flow digital twin (MF-DT), and is described in detail in international application no. PCT/EP2021/056706, PCT/EP2020/088051 and PCT/EP2020/088053, which are incorporated herein by reference. Further, the simulation capabilities of a MF-DT using discrete event simulation are discussed in JUHLIN et al. Metamodeling of Cyber-Physical Production Systems using AutomationML for Collaborative Innovation. In IEEE 26th International Conference on ETFA 2021; and in KESHARI et al. Discrete Event Simulation Approach for Energy Efficient Resource Management in Paper & Pulp Industry. In: 6th CIRP Global Web Conference 2018.

Optionally, several MF-DTs can run in parallel. The MF-DT(s) can be run, for example, on plant-edge level.

The simulation capability of the MF-DTs can be used to extract online quality information (e.g., determined based on quality attributes of material portions of the MF-DTs) at desired locations over time. This quality information can be output to virtual quality control systems (virtual QCSs) comprising soft sensors. Thus, an output of the virtual measurement by the soft sensors can, for example, be outputted to a controller for controlling an aspect of the paper production process. Also, utilizing the MF-DT for the quality estimation in this manner may allow the (virtual) measurements by soft sensors at arbitrary positions within the paper production process. The general concept of soft sensors, as used herein, is described in further detail, for example, in BRUNNER et al. Challenges in the Development of Soft Sensors for Bioprocesses: A Critical Review. In: frontiers in Bioengineering and Biotechnology, 20 Aug. 2021.

For determining the quality attributes of the material portions, machine learning, deep learning or filter techniques can be utilized. The output of the MF-DT based virtual measurement can be combined with measurement data from real measurements obtained from QCSs, laboratory measurements or visual data from video systems to train the prediction process and achieve higher prediction accuracy. By using data obtained from real measurements, the accuracy of the predictions based on the MF-DT can be increased over time to optimize the quality estimation system. Herein, the optimizing may include minimizing a discrepancy between the real measurement data from hardware sensors and the (virtual) measurements from soft sensors at the same location and at the same time, the virtual measurements being based on the MF-DT simulations.

The methods of this disclosure provide an operator of the paper production process with a more detailed information, in an online manner, of quality attributes by utilizing a data fusion-based prediction approach. The methods may comprise some or all elements of the following steps, listed in an arbitrary order.
Correlation of Data: For correlation of data various available online and offline data sources are used in combination. Therefore, data like time series quality measurements, time series MF-DT soft sensor readings of quality signals or structured data quality laboratory measurements from different sources can be fetched on plant-edge level. The data can then be correlated to align the time stamps and provide predictors for the quality attributes. Therefore, Machine Learning/Deep Learning approaches can be applied. These run for example in the calculation engine of the edge device providing predictions. The aligned time series signals are added to the MF-DT. Example prediction algorithms are described, for example, in Ali Abusnina: Gaussian Process Adaptive Soft Sensors and their Applications in Inferential Control Systems, University of York, 2014. Further, an overview is given by Donald Stanly, ChangYuan Liua and John Schroeder of ABB in ABB: Online paper property calculations get smarter with machine-learning-based soft sensors (retrieved from https://new.abb.com/pulp-paper/abb-in-pulp-and-paper/articles/online-paper-property-calculations-get-smarter-with-machine-learning-based-soft-sensors).
Extract information from MF-DT: The operator can use the MF-DT to calculate quality attributes online at all process steps the operator is interested in. The MF-DT can be implemented in the edge device and provides the material view on the process. 2D information based on simulations as well as the Machine Learning/Deep Learning-based predictions can be provided continuously over time. A model-based robust soft sensor is described in DORAISWAMI et al. Robust Model-Based Soft Sensor: Design And Application. In: Reprints of the 19th World Congress of The IFAC, Cape Town 2014.
MF-DT and QCS in parallel: The soft sensor readings can be continuously compared with the real measurements from the QCS. Therefore MF-DT predictions need to be available for locations where QCS readings are available. Usually, there will be deviations between soft sensor readings and physical sensor readings e.g. due to not modelled effects in the simulator of the MF-DT or sensor noise. The impact of not modelled effects and sensor noise with respect to a Particle Filter is discussed by Henrique Fonseca, Cesar Pacheco, Wellington Betencurte and Julio Dutra, Kalman and Particle Filters Part B: Particle Filters Application to control of dynamic systems. In IMPA, Rio de Janeiro 2017.
Filter Techniques to update MF-DT online: The deviations can be reduced over time by constantly adapting the predictions from the MF-DT. Therefore, classical filter techniques like Kalman Filter and Particle Filtering can be applied. Kalman filter techniques are described in FRANçOIS et al. Industrial applications of the Kalman filter. In: IEEE Transactions on Industrial Electronics 2013. An overview of the particle filter is given in Fredrik Gustafsson, Particle Filter Theory and Practice with Positioning Applications. In: IEEE Aerospace and electronic systems magazine, (25), 7, 53-81, 2010. Hence, the general prediction quality of the MF-DT is increased also at locations where no physical sensor reading is available. A validation step of the MF-DT can also be done based on historic data to determine a good performance of the MFDT-based prediction process. How to maintain a soft sensor model is described in CHEN et al. Soft Sensor Model Maintenance: A Case Study in Industrial Processes. In: 9th International Symposium on Advanced Control of Chemical Processes, Whistler (Canada), 2015.
Filter Techniques to predict quality attributes: The prediction step of the filter can be used to derive predictions of quality attributes for locations the operator is interested in, even immediately without delay for offline tests.
Improve sensor correlation activities: The MF-DT can establish a relation between different physical sensors. Correlation analysis between these predicted sensor signals can be used to identify faulty sensors or need for calibration/standardization e.g. based on Machine Learning/Deep Learning or expert knowledge. In general, the approach can also be used to increase sensor quality by reducing noise levels. An example of an industrial application of a ML algorithm is described by Hosny Abbas, Machine Learning for Paper Grammage Prediction Based on Sensor Measurements in Paper Mills (arXiv: 1910.06908).
MF-DT as early warning for erroneous behavior: A validated MF-DT can warn early for bad quality or even erroneous behavior, not only at the end as opposed to the QCS. It offers possibility for automatic adaptations of the production, i.e. Virtual Paper Management.

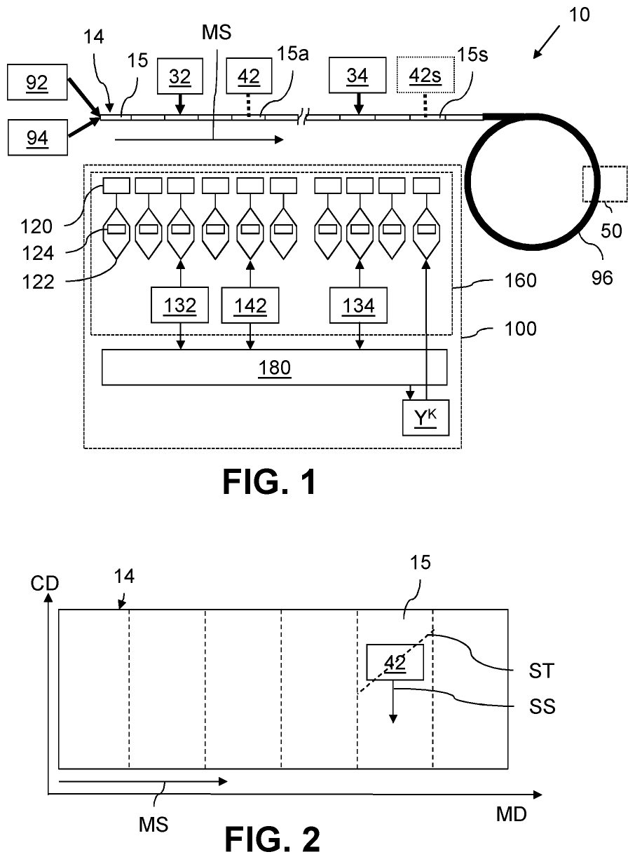

Next, an embodiment of the present disclosure is described with reference to FIG. 1. FIG. 1 illustrates a quality estimation system (100) for a continuous paper production processing line (10). In the continuous paper production processing line (10), a flow of material (14) is processed for producing a paper product (96). Thereby, raw materials (92, 94) form a sheet-like material (14) which is then further transported along the processing line (10) and processed. Along the processing line (10), processing devices (32, 34) are provided which process the flow of material (14) into the paper product (96). Further, quality control systems (QCSs) can be placed along the processing line (10). The QCSs can comprise a sensor (42) such as a QCS scanner beam, to obtain a stream of measured quantities (142) relating to the processed material (14).

The quality estimation system (100) is based on a MF-DT as a soft sensor for quality measurements. The MF-DT can be a virtual representation of the real continuous paper process (10). The MF-DT comprises at least one process model (160) and at least one material portion representor (120) (“blob”).

The quality estimation system (100) comprises at least one process model (160). The process model (160) can be specific for the paper production process. The paper production process can be virtually split into sub-systems and the process model (160) can be specific for sub-systems of the continuous paper production process. The process model (160) influences the simulation module of the MF-DT.

The material representors (120) are virtual representations of virtually divided real material portions (15). The material representors (120) comprise a data container (122) for storing at least one quality attribute (124). The at least one quality attribute describes quality of the respective real material portion (15). The at least one quality attribute can be a 1D quality attribute or a 2D quality attribute.

The quality estimation system (100) further includes process simulation modules (132, 134). The process simulation modules (132, 134) correspond to the processing devices (32, 34). The process simulation modules (132, 134) modify attributes of the material representors (120) based on the respective processing device (32, 34).

The quality estimation system further includes a filter module (180). The filter module (180) can be a Kalman filter, a Particle filter or any other suitable filter. The filter module can be used to update the MF-DT to improve prediction quality over time. Further, historical data can be used to update the MF-DT. The prediction step of the filter module (180) can be used to derive predictions of 2D quality signals at arbitrary locations. The prediction step of the filter module (180) can be immediately, i.e. without delay, for offline tests.

Thereby, according to an embodiment, it is possible to monitor a continuous paper production process and to provide a soft sensor for on-line quality measurements. The soft sensor is based on data from a material flow digital twin (MF-DT). Particular embodiments allow not only to run, but also to continuously improve and check the MF-DT in order to allow an accurate soft sensor output for quality measurements.

As described above with respect to FIG. 1, the MF-DT has (or is) a process model (160) and models the material flow by material portion representors (120) (“blobs”), the material portion representors being virtual representations in the process model of virtually discretized material portions (15) within the continuous flow of material (14) being processed. The material flow through the process is modelled by these discretized material portions (15) and their material portion representors (120). The process is virtually split into the process simulation modules (132, 134), each representing the processing devices (32, 34) of the physical paper production process, e.g. diluting section, wire section, press section, drying section or finishing section.

The MF-DT simulation capability is based on discrete event simulation, e.g. in Python or any commercially available Discrete Event Simulator Tool (DES). The processor models underlying the process simulation modules (132, 134) can be tool agnostic or made available via Functional Mockup Units (FMU).

Data from different sources is aligned and combined, therefore Machine Learning/Deep Learning is used to correlate data and provide predictions. The data is added to the MF-DT. Information is extracted from the MF-DT: The simulation capability of the MF-DT is used to extract online quality information at a desired location over time. The MF-DT and the QCS are run in parallel. The MF-DT predictions and quality sensor readings can be run in the edge in parallel. Deviations will be visible due to MF-DT model mismatch and sensor noise. Filter techniques can be used to update the MF-DT models to improve the prediction quality over time. In particular, the filter module (180) can be used to update the MF-DT. The MF-DT is validated also with historic data. The prediction step of the filter module (180) can be used to extract quality attributes at the desired location, even in real-time without offline test delays. All existing physical sensors can be correlated using the MF-DT. The MF-DT can warn and recommend adaptations for erroneous behavior

The material portion representors (120) have a data container (122) describing the material at any specific material step. The data container (122) holds all attributes (124) of interest, e.g., material quality attributes and Key Performance Indicators (KPIs). These attributes and KPIs are modified by the DES according to the processor models.

The data container (122) may for example have a tracking section for storing tracking information, such as past events and related KPIs. The data container (122) may further have a quality attribute section for storing quality attributes or KPIs, such as Size and Tonnage. Further storage sections may include data fields such as “ID” and “order” providing information from the MES/ERP system, and/or “Origin”, “Location”, and “time” indicating where the material portion was (virtually) created and where it currently is in the system.

The MF-DT simulation can run in parallel to the real system and provide predictions with respect to time for the given prediction/simulation horizon.

For example, if the simulation is triggered at a given time t₁, it can provide predictions for a given simulation horizon from t₁ to t₁+Δt_{horizon}. The simulation is instantiated using the real process and material state values (if known). Like for all simulations the prediction quality usually decreases for longer prediction horizons:

Several simulation instances can run in parallel, triggered at the same or at different times t₁, and with the same or different values for Δt_{horizon}. For example, two simulations can start at consecutive times, the second one at a starting time later than t₁ but before t₁+Δt_{horizon}, in order to allow simulation results to be continuously available in the time interval covered by the simulations. As another example, two simulations can also start at the same time, but with different simulation horizons.

As material flows through the system, quality sensors of the QCS can measure specific quality attributes of the material in machine direction (MD) or in cross-machine direction (CD). Since sensor devices may be expensive and/or require space, only a specific small area of the material is measured at once. For example, as shown in FIG. 2, a typical sensor (42) produces measurement results only in a 1D sensor trajectory, namely in a linear combination of machine and cross-machine direction depending on machine and sensor speed: The sensor (42) is capable of performing a stream of measurements, each at a given location for every point in time, resulting in measurements along a 1-dimensional sensor trajectory ST when the paper material (14) moves with a machine speed MS in machine direction MD and the sensor moves with sensor speed SS in cross-machine direction CD. The trajectory itself depends on the sensor speed SS and the machine speed MS.

The sensor measurements of the sensor (42) may then be recorded, together with a time stamp and their position on the respective material portion (15) along the sensor trajectory ST, in the corresponding material portion representor.

Hence, for each material section (15), a 1D measurement trajectory ST is available for the sensor (42). For the rest of the material of the material portion (15), the quality attributes can, however, be estimated as described herein.

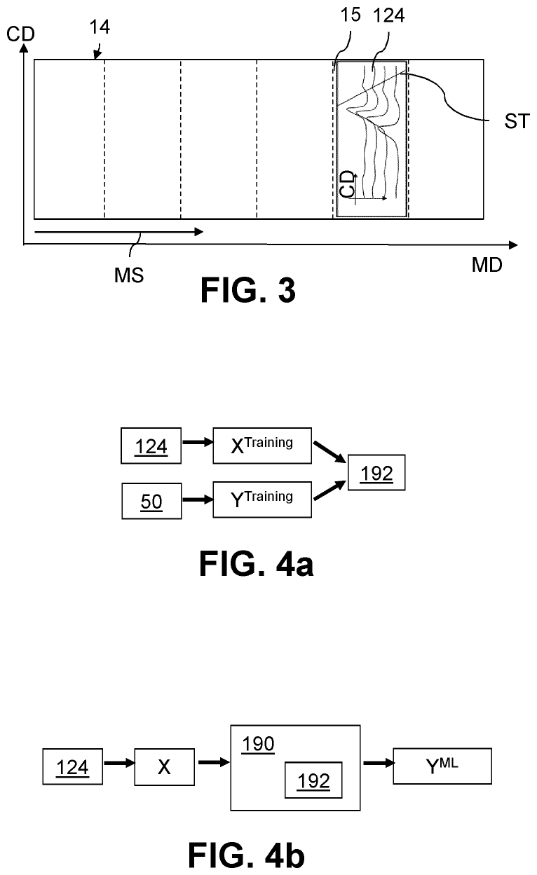

According to an embodiment of the present disclosure, the material portion representor holds quality attributes not only in 1D but in 2D, spanning the area of the material portion in MD and CD. These quality attributes (124), e.g. KPIs, are illustrated in FIG. 3, as a series of virtual measurements spanning the entire cross-machine direction CD of the material portion (15) for each measurement, even though the actual hardware measurement is done only along the sensor trajectory ST as described above with reference to FIG. 2. These virtual measurements are the results of a simulation by the process model (160), and may be changed or updated in each processing device (32, 34) of the paper machine according to the processor model. Thus, the KPIs and 2D quality attributes are changed according to the process model. Instead of only reflecting the sensor values along a 1D trajectory as shown in FIG. 2, the MF-DT can provide quality attributes (124) in 2D.

For each sensor (e.g. a 1D sensor as described above with reference to FIG. 2 or a higher-dimensional sensor such as a web imaging system) measurement data can be added to the data container (122) of the respective material portion representor (120).

This way the MF-DT contains a material flow-oriented container of measurements, process information and quality information relating to the respective material portion (15). This MF-DT container information may contain data available in 2D at all locations for all points in time. Due to the material portion concept, it can always be linked to the real material (14).

This concept also allows for the configuration of soft sensors, i.e., virtual sensors that behave like hardware sensors but generate the sensor data based on the quality attributes (124) stored in the material portion representors (120). Thus, quality sensors like e.g., thickness sensor can also be built as soft sensors based on the digital twin.

In contrast to the physical sensor beam, the virtual sensor beam of a soft sensor can be placed everywhere in the system, and as many sensors as wanted or needed can be defined. Also, the virtual sensor beam of the soft sensor can provide values in 2D instead of only 1D. By this, measurements can be retrieved where this would otherwise not be possible in reality using a hardware sensor e.g. due to space limitations.

The MF-DT simulation may have errors and deviations with respect to the underlying reality similar to hardware sensor. For example, when different simulations are performed, every simulation may provide a different virtual sensor measurement. In an example, new simulation runs are triggered at three different times t₁, t₂, and t₃. All runs are initialized using the real sensor value. At a time within the respective simulation horizons of a plurality of these simulations, the results of these simulations may not be identical.

The predictions of the MF-DT simulations can be done using model functions linking the sensor readings and other process inputs to the prediction outputs. According to embodiments, the predictions can be improved using Machine Learning/Deep Learning, and/or Filter Techniques.

In the following, an approach for improving the simulations using Machine Learning/Deep Learning is described.

In addition to the physical sensor readings from quality sensors or web imaging systems, laboratory measurement reports are available. There, paper samples are taken and analyzed in more detail, thereby obtaining laboratory data (e.g., from a Laboratory Information Management System). These samples can only be taken at the end of a process and the analysis takes time, i.e., is not available in an online manner. The MF-DT allows to align the laboratory sample with the sensor reading of the quality sensor in the beam and/or the virtual sensor reading from the MF-DT.

These aligned datasets can be used for building a machine learning model/deep learning model and to identify predictors for quality issues in the product. Specifically, the real and/or virtual sensor reading are used as input values X=X^{Training} and the laboratory values and/or sensor outputs calculated from the laboratory values are used as prediction values Y^{Training}.

Specifically, with reference to FIG. 4a, a method of training a machine-learning system for improving the predictions can comprise all or some of the following steps:
1. Laboratory Reports are extracted from the Laboratory Information Management System (LIMS).
2. Quality attribute information like e.g. thickness is extracted
3. Quality attribute information from all reports is turned into time series information Y, here referred to as Y^{Training}, mapping time of sample extraction/role/product pass to quality attributes. YϵR^{n×m}, where n is the number of quality attributes under consideration and m the number of available reports/time stamps. The same format Yϵ^{R×m} will later be used for the output value for the machine learning algorithm.
4. The user selects a location in the process, not necessarily a location where sensor readings are available.
5. The MFDT is used to identify which material portion representor (“blob”) contains related information to the time stamps of the time series Y^{Training}. Use the tracking information of the material portion representors to identify which material portion representor was measured at the time of laboratory sampling.
6. Extract from each of the relevant material portion representors all available relevant quality attributes (124). These include value metrics as well as other KPIs available from the system, collectively referred to as available material portion data (which will also later be available as input values for the predictions). For each relevant material portion representor, all these values are stored in a respective “available attributes” container X=X^{Training}, e.g., time series matrix XϵR^{p×m}, where p is the number of attributes under consideration and available from the material portion representor, and m the number of available reports/time stamps linked to the material portion representors. The “available attributes” container X contains data only for the material portion representor under consideration. The data of type X will later be the feature matrix in the machine learning algorithm.
7 Feed the data combination X^{Training} and Y^{Training} to a machine learning algorithm (190) for determining the machine learning parameters (192) for which the machine learning algorithm optimally predicts Y^{Training} for the input X^{Training}. The machine learning algorithm may run on the same device on which the MF-DT is running, e.g. a dedicated machine learning unit on the same edge device, or on another device, e.g. a cloud-based system, another edge device or a dedicated machine learning unit on the same edge device. If necessary, for carrying out the machine-learning algorithm, data may be transferred from the MF DT, e.g., implemented in the edge device, to the system on which the machine learning algorithm is running. The machine learning unit uses regression algorithms to build machine learning prediction models, e.g. by determining the machine learning parameters (192).

As illustrated in FIG. 4b, the machine-learning algorithm (190) trained in this manner, using the machine learning parameters (192), is capable of predicting values of Y=Y^{ML} using, as input values, the available attributes container X obtained from the data available for the respective material portion. Thus, the machine-learning algorithm determines the prediction data Y^{ML}, having the data format Y as described above, based on the value metrics as well as other KPIs. According to an embodiment, the prediction algorithm determines the predicted data Y only for a selected one of the material portions, using only input variables X relating to the selected material portion, but not to other material portions.

The predicted quality attributes Y^{ML} correspond to the training quality attributes Y^{Training} used in the above learning phase, and have the same data structure Y.

The prediction models may either be implemented
a. in the calculation engine of the plant edge device to provide continuously quality attribute (124) predictions.
b. in the MF-DT to provide soft sensors of the predicted quality of the paper. This works also backwards in time for historic material representors.
c. In the cloud platform to provide the models also to other plants

The above learning process may be repeated from time to time if more laboratory measurements become available, either for freshly determining or for updating the machine learning parameters.

Further, the prediction performance may be determined by comparing predictions with the laboratory measurements. If the predictions deviate too much from the laboratory measurements, e.g., by more than a predetermined threshold, a retraining routine may be triggered, by which the model is retrained as described above.

The resulting machine learning model/deep learning model can be implemented in the calculation engine of a plant edge device or a beam edge device to improve the existing sensor device by providing not only actual readings but also predictions about the product. In addition to this, the predictions can also be added to the MF-DT.

Especially if implemented in the calculation engine, the predictions can be used to generate alarms or notifications for the operator.

The operator can use this information to make changes to the process operation, e.g. by tuning control loops. The production planner can use this information to early decide on how to use the resulting paper, i.e. sell it or reuse it.

The more laboratory data that is available, the better the prediction will become over time. Hence, also the prediction quality of the MF-DT simulation will increase.

An alternative or additional approach to increase the prediction performance is to apply filter techniques. These filter techniques are described in the following.

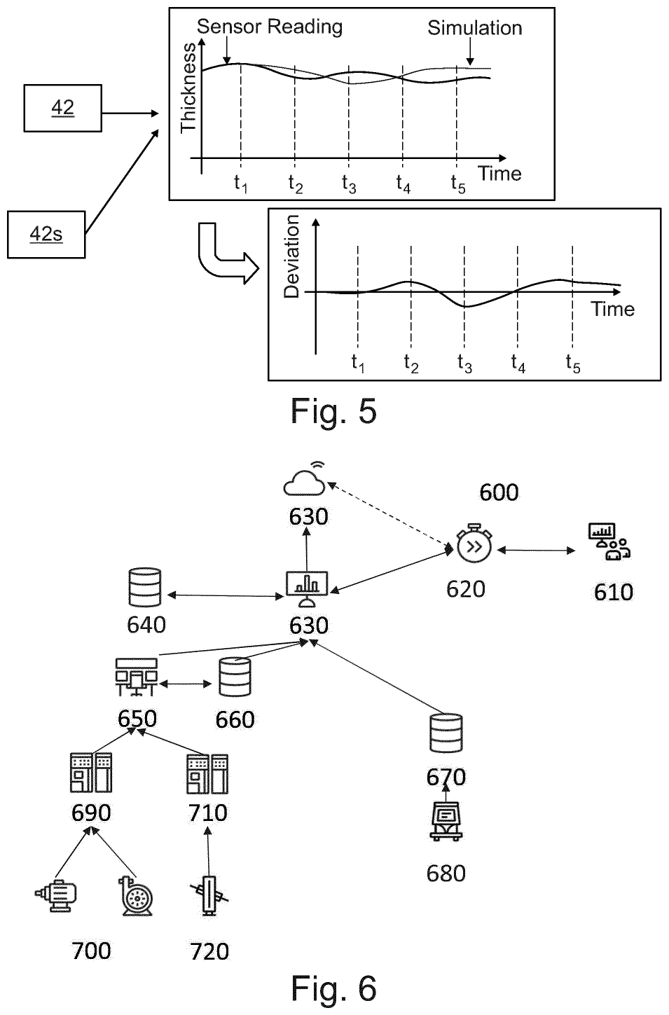

According to the embodiment shown in FIG. 5, a physical sensor (42) and a virtual sensor (42s), using the output of the MF-DT prediction model, are used in parallel. Both provide sensor readings which can be compared to get a deviation signal. In the example of FIG. 5, these sensor readings are a thickness, but the embodiment is not limited to thickness, and any other sensor reading may be used in place thereof.

Filter techniques like Kalman Filter or Particle Filter use this deviation signal to adapt the simulation model over time, so that the deviation value decreases over time. At the core of the Filter techniques lies a feedback loop, whereby
a) quality parameters are predicted using the MF-DT simulation, with adjustable parameters, e.g. as an output of a virtual sensor;
b) these quality parameters, or a subset thereof, are measured using a real sensor; and
c) the adjustable parameters are adjusted for minimizing a deviation between a) and b), using filter techniques.

Thereby, the MF-DT-based filter is used as a predictor for quality attributes.

Advantages of these techniques are:
Adaptability: In case of minor changes, the filter will adapt the model automatically
Scalability: Modification made at one place should also improve the predictions at other locations, e.g. where no physical sensor device is installed
Modularity: If more sensor readings are available, these can also be used in the same filter
Noise-suppression: Correlation analysis between the sensor signals can be used to reduce noise levels of sensor readings

The resulting predictions from the MF-DT can be fused with data from an existing Video Monitoring System. For example, the data from the Video Monitoring System, or a reduced dataset obtained therefrom, can be used as a sensor input in an analogous manner to any other sensor input from a sensor (42).

Several different approaches for improving the MF-DT can be combined by using a first approach as an input to a second approach (stacking). For example, when both a machine-learning prediction model and a Kalman filter based model are used, the output from the machine-learning prediction model can be used as yet another input for the Kalman filter based model, treated on the same footing as other, e.g., sensor-based, inputs like input (142) shown in FIG. 1. Likewise, the output from the Kalman filter based prediction model can be used as yet another input for the machine-learning algorithm, included in the input parameters X shown in FIG. 4b.

According to an embodiment, the prediction algorithm can be used for failure detection. For example, whenever one of the following values:
MF-DT-prediction
Sensor reading
Web Imaging System
Machine Learning/Deep Learning Prediction
is not sufficiently aligned with the other values, e.g., a deviation from the other values or from their average exceeding a predetermined deviation threshold, a failure is determined. In a simple case this results in an error message, e.g., triggering a message that the sensor is faulty. Also, such an error message may be used as an indicator for a paper sheet break.

Therefore, it is useful to provide one or more of the following failure signals F1 to F3 to the operator:

$$\begin{matrix}- F 1 = quality sensor reading - MF - DT soft sensor prediction \\ - F 2 = web imaging system - MF - DT soft sensor prediction \\ - F 3 = Machine Learning / Deep Learning Prediction - paper specification from MF - DT\end{matrix}$$

If any of these signals F1 to F3 exceeds a predefined threshold, a warning message or operator alarm may be triggered.

FIG. 6 illustrates a control structure (600) of a paper production process according to an embodiment. The control structure (600) can be operated by a human operator (610). The control structure (600) utilizes a simulation (620) running on a calculation engine (630). The simulation can be according to a quality estimation system as described in this disclosure or any other suitable simulation. The simulation can be run on either an edge device or a cloud, i.e. the calculation engine (630) can be an edge device or a cloud. In an embodiment where the calculation engine (630) is an edge device, the calculation engine (630) can further be connected to a cloud and the calculation engine (630) can upload data to the cloud. The simulation (620) can output simulation data to the human operator (610)

The calculation engine can be connected to a data storage unit (640), the data storage unit (640) may contain historic process data. The calculation engine (640) can retrieve historic process data or store data in the data storage unit (640). When the calculation engine (640) stores data in the data storage unit (640), the stored data becomes historic process data stored in the storage unit (640).

Further, the calculation engine (630) can be connected to a distributed control system (DCS) (650). The calculation engine (630) can receive data from the DCS (650). The DCS (650) has an associated data storage unit (660) which can either be connected directly to the calculation engine (630) or via the DCS (650) or directly and via the DCS (650). The data storage unit (660) may contain historic DCS data. The DCS (650) can retrieve historic DCS data or store data in the data storage unit (660). When the DCS (650) stores data in the data storage unit (660), the stored data becomes historic DCS data stored in the storage unit (660). The calculation engine (630) can either retrieve historic DCS data directly from the storage unit (660) or via the DCS (650).

Further the calculation engine (630) can be connected to a data storage unit (670) of a paper testing instrument (680). The paper testing instrument can be a Laboratory Information Management System or any other instrument which allows for paper testing. The data storage unit (670) may contain process data from the paper testing instrument (680). The data storage unit (670) may receive and store data from the paper testing instrument (680). The calculation engine (630) may retrieve data from the data storage unit (670).

The DCS (650) can be connected to a first PLC (690). The first PLC (690) can be connected to the machinery (700) of the paper production process. The machinery (700) of the paper production can comprise all engines of the paper production process which can be controlled with a computer implemented device, e.g. engine for conveyer belt drive and heaters. The first PLC (690) can retrieve data from the machinery (700) of the paper production process. The DCS (650) can retrieve data from the first PLC (690). The DCS (650) can be connected to a second PLC (710). The second PLC (710) can be connected to quality control systems (QCS) of the paper production process (720). The second PLC (710) can retrieve data from the QCS (720) of the paper production process. The DCS (650) can retrieve data from the second PLC (710). The DCS (650) can be connected to further PLC systems which can be connected to further subprocesses of the paper production process, e.g. video surveillance systems. The further PLC systems can retrieve data from the further subprocesses. The DCS (650) can retrieve data from the further PLC systems.

The present disclosure further relates to a method to monitor the paper production process (10) using the quality estimation system (100), the paper production process being a continuous process wherein the continuous flow of material (14) is being processed. The paper production process can be a continuous process wherein the continuous flow of material (14) is being processed into the paper product (96).

According to an aspect, the paper production process further can comprise quality control systems (QCSs) with a QCS scanner beam. The Sensor (42) can be attached to the QCS scanner beam. The QCSs can be positioned at distinct positions within the paper production process (10) where suitable. The stream of measured quantities (142) can be measured using the sensor (42). The stream of measured quantities can be measured along a sensor trajectory within the material portions (15). The sensor trajectory lies in the plane of machine direction and cross-machine direction and is determined by machine speed and sensor speed.

According to an aspect, the quality estimation system (100) can be based on a MF-DT acting as a soft sensor. The MF-DT can be modelled after the paper production process (10). The MF-DT comprises the process model (160) and the material portion representors (120).

The quality estimation system (100) comprises the process model (160) specific for at least a portion of the paper production process (10). In particular, the paper production process (10) can be virtually split into sub-systems and the process model (160) can be specific for sub-systems of the continuous paper production process. The process model (160) influences the simulation module of the MF-DT.

The quality estimation system further comprises material portion representors (120) being virtual representations in the process model of material portions (15) within the continuous flow of material (14) being processed (into a paper product (96)). In particular, the material portions (15) can be virtually discretized portions within the continuous flow of material (14). The material portion representors (120) comprise the data container (122) in which quality attributes and key performance indicators (KPIs) are stored. Each of the material portion representors (120) comprises at least one quality attribute (124) for the respective material portion (15). The material portion representors (120) can comprise multiple quality attributes (124) and KPIs.

The method comprises determining (e.g., measuring), using the sensor (42), the stream of measured quantities (142) of the material (14) being processed. The sensor (42) can be attached to a QCS scanner beam.

The method further comprises associating respective time stamps with the measured quantities. For each of the measured quantities, using the associated time stamps, an associated material portion (15a) of the material portions (15) and an associated position within the associated material portion (15a), respectively, is determined. Thereby for each of the measured quantities and using the associated time stamps, respectively, an associated material portion (15a) of the material portions (15) is associated with the respective measured quantity.

The method further comprises: determining for the selected material portion (15s) of the material portions (15), the at least one quality attribute (124) based on the measured quantities (142) to which the selected material portion (15s) is associated and on the associated position with the selected material portion (15s) and outputting the determined at least on quality attribute (124).

According to an aspect, the at least one quality attribute (124) can be extracted from the MF-DT. The quality attribute (124) can be calculated for all process steps from the MF-DT. The quality attribute can be predicted using the machine learning/deep learning model. The quality attribute can be predicted using the filter module (180). In particular using the Kalman filter or Particle Filter.

According to one embodiment the at least one quality attribute (124) comprises a plurality of position-dependent quality attributes representing a two-dimensional spatial distribution of a respective quality attribute within the respective material portion (15). In particular, the two-dimensional spatial distribution can be discrete grid points generating a mesh, wherein quality attributes are associated to the grind points. In one particular embodiment, between two grid points of the mesh the quality attribute can be constant. In another particular embodiment, the quality attribute can jump between a first and second grid point. One non-limiting example therefore being, starting from a first grid point, the quality attribute can be constant up until a predetermined distance, after which the quality attribute has the value of the second grid point. The predetermined distance can be the halfway point between the two grid points. In yet another particular embodiment, the quality attribute can change in a linear or any other suitable function between the two grid points.

According to one embodiment the at least one quality attribute (124) is determined based on only those of the measured quantities (142) to which the selected material portion (15s) is associated. For determining the at least one quality attribute (124) no measured quantities to which other material portions, other than the selected material portion (15s), are associated are used. In particular, the at least one quality attribute without interrelation with material representors (120) (without influence from other material representors (120)).

According to one embodiment the at least one quality attribute (124) is determined based on measured quantities (142) to which more than one selected material portion (15s) is associated. In particular interrelation between material representors (120) is utilized to determine the at least one quality attribute (124).

According to one embodiment the stream of measured quantities is measured in an on-line manner and the at least one quality attribute (124) is outputted in a real-time manner to a soft sensor output interface. In a further embodiment, the on-line data can be a predetermined measurement defined by a predetermined set of instructions. The predetermined set of instructions can be stored on a storage medium and executed by a suitable device.

According to one embodiment the soft sensor output interface has stored a flexibly configurable virtual sensor position, and wherein the soft sensor output interface determines a sensor output at the virtual sensor position using the at least one quality attribute (124) determined for the selected one (15s) of the material portions (15) being the material portion at the virtual sensor position. In a particular embodiment the soft sensor output interface has stored a set of predetermined virtual sensor positions, the set containing multiple predetermined virtual sensor positions, and wherein the soft sensor output interface determines a sensor output at the virtual sensor position using the at least on quality attribute (124) determined for the selected one (15s) of the material portions (15) being the material portion at the virtual sensor position in an automated way, respectively for each predetermined virtual sensor position in the set of predetermined virtual sensor positions.

In one embodiment real sensor data is measured using a sensor at a predetermined position; and determining a sensor data deviation of the virtual sensor data at the virtual sensor position being selected as the predetermined position from the real sensor data. Thereby, the virtual sensor position corresponds to the predetermined position of the (real) sensor.

In one embodiment laboratory data is measured representing at least a portion of the at least one quality attribute and determining a laboratory data deviation between the laboratory data and the outputted at least one quality attribute (124).

In one embodiment an excessive sensor data deviation and/or an excessive laboratory data deviation triggers a warning message. In particular, the excessive sensor data deviation and excessive laboratory data deviation corresponds to the sensor data deviation and laboratory data deviation exceeding a predetermined sensor data deviation threshold and laboratory data deviation threshold, respectively.

In one embodiment the at least one quality attribute (124) is determined using a process model of the paper production process, the process model modelling the production process by manipulating the material portion representors (120) based on process steps of the paper production process to which the respective material portions (15) are subjected. In particular, the process model is manipulating the at least one quality attribute (124).

In one embodiment the at least one quality attribute (124) is determined using a discrete event simulation of the paper production process, the discrete event simulation manipulating the material portion representors (120) based on the measured quantities (142) to which the respective material portions (15) are associated, in some embodiments the discrete event simulation comprising a filter such as at least one of a Kalman filter and a Particle filter for adjusting parameters of the discrete event simulation based on the measured quantities (142). In particular, the discrete event simulation is manipulating the at least one quality attribute (124).

The prediction based on the MF-DT will have deviations with respect to the real measurement data. According to an aspect, the filter module (180) can be used to update the MF-DT to improve the prediction quality over time. Additionally, historic data can be used to update the MF-DT.

In one embodiment the at least one quality attribute (124) is determined using a machine-learning function (190) outputting the at least one quality attribute (124) as a function of the measured quantities (142), the machine-learning function (190) having been trained using laboratory measurements data representing the at least one quality attribute. In particular, the machine-learning function (190) can be a function of the measured quantities and further input parameters.

In one embodiment the machine-learning function (190) outputs the at least one quality attribute (124) as a function of the measured quantities (142) and of an output of the discrete event simulation.

In one embodiment the discrete event simulation manipulates the material portion representors (120) based on the measured quantities (142) and on an output of the machine-learning function (190).

In one embodiment the sensor (42) comprises an optical camera system, and wherein the stream of measured quantities (142) comprises an optical image of the material (14) being processed.

According to an aspect, the method can be run at least partially in the plant-edge level or on a cloud. In particular, the step of determining the at least one quality attribute can be carried out by at least one of an edge device running at a plant edge level, and/or a cloud platform accessible over a data network. The outputting may be carried out over a network interface for connecting the device to the data network. The data network may be a global data network. The data network may be a TCP/IP network such as Internet. The data network may comprise distributed storage units such as Cloud. Depending on the application, the Cloud can be in form of public, private, hybrid or community Cloud.

1-15. (canceled)

16. A method of monitoring a paper production process using a quality estimation system, the paper production process being a continuous process wherein a continuous flow of material is being processed,
the quality estimation system comprising:
a process model specific for at least a portion of the paper production process; and
material portion representors being virtual representations in the process model of material portions within the continuous flow of material being processed, each of the material portion representors comprising at least one quality attribute for the respective material portion,
the method comprising:
determining, using a sensor, a stream of measured quantities of the material being processed;
associating respective time stamps with the measured quantities;
determining, for each of the measured quantities and using the associated time stamps, respectively:
(i) an associated material portion of the material portions, and
(ii) an associated position within the associated material portion;
determining, for a selected material portion of the material portions, the at least one quality attribute based on the measured quantities to which the selected material portion is associated and on the associated position within the selected material portion; and
outputting the determined at least one quality attribute.

17. The method of claim 16, wherein the at least one quality attribute comprises a plurality of position-dependent quality attributes representing a two-dimensional spatial distribution of a respective quality attribute within the respective material portion.

18. The method of claim 16, wherein the at least one quality attribute is determined based on only those of the measured quantities to which the selected material portion is associated.

19. The method of claim 16, wherein the stream of measured quantities is measured in an on-line manner and the at least one quality attribute is outputted in a real-time manner to a soft sensor output interface.

20. The method of claim 19, wherein the soft sensor output interface has stored a flexibly configurable virtual sensor position, and wherein the soft sensor output interface determines a sensor output at the virtual sensor position using the at least one quality attribute determined for the selected one of the material portions being the material portion at the virtual sensor position.

21. The method of claim 19, further comprising measuring real sensor data using a sensor at a predetermined position; and determining a sensor data deviation of virtual sensor data from the real sensor data, the virtual sensor data being taken at the virtual sensor position being selected as the predetermined position.

22. The method of claim 20, further comprising measuring real sensor data using a sensor at a predetermined position; and determining a sensor data deviation of virtual sensor data from the real sensor data, the virtual sensor data being taken at the virtual sensor position being selected as the predetermined position.

23. The method of claim 16, further comprising obtaining laboratory data from a laboratory analysis of the processed material, the laboratory data being indicative of at least a portion of the at least one quality attribute; and determining a laboratory data deviation between the laboratory data and the outputted at least one quality attribute.

24. The method of claim 21, wherein an excessive sensor data deviation and/or an excessive laboratory data deviation triggers a warning message.

25. The method of claim 23, wherein an excessive sensor data deviation and/or an excessive laboratory data deviation triggers a warning message.

26. The method of claim 16, wherein the at least one quality attribute is determined using a process model of the paper production process, the process model modelling the production process by manipulating the material portion representors based on process steps of the paper production process to which the respective material portions are subjected.

27. The method of claim 23, wherein the at least one quality attribute is determined using a process model of the paper production process, the process model modelling the production process by manipulating the material portion representors based on process steps of the paper production process to which the respective material portions are subjected.

28. The method of claim 16, wherein the at least one quality attribute is determined using a simulation of the paper production process, the simulation manipulating the material portion representors based on the measured quantities to which the respective material portions are associated, the simulation preferably being a discrete event simulation and/or comprising a filter such as at least one of a Kalman filter and a Particle filter for adjusting parameters of the discrete event simulation based on the measured quantities.

29. The method of claim 23, wherein the at least one quality attribute is determined using a simulation of the paper production process, the simulation manipulating the material portion representors based on the measured quantities to which the respective material portions are associated, the simulation preferably being a discrete event simulation and/or comprising a filter such as at least one of a Kalman filter and a Particle filter for adjusting parameters of the discrete event simulation based on the measured quantities.

30. The method of claim 16, wherein the at least one quality attribute is determined using a machine-learning function outputting the at least one quality attribute as a function of the measured quantities, the machine-learning function having been trained using laboratory measurements data representing the at least one quality attribute.

31. The method of claim 29, wherein the at least one quality attribute is determined using a machine-learning function outputting the at least one quality attribute as a function of the measured quantities, the machine-learning function having been trained using laboratory measurements data representing the at least one quality attribute.

32. The method of claim 31, wherein
the machine-learning function outputs the at least one quality attribute as a function of the measured quantities and of an output of the simulation; or wherein
the simulation manipulates the material portion representors based on the measured quantities and on an output of the machine-learning function.

33. The method of claim 16, wherein the sensor comprises an optical camera system, and wherein the stream of measured quantities comprises an optical image of the material being processed.

34. The method of claim 16, wherein the at least one quality attribute is determined by at least one of an edge device running at a plant edge level; or a cloud platform accessible over a network such as Internet.

35. A quality estimation system for a paper production process, the paper production process being a continuous process wherein a continuous flow of material is being processed,
the quality estimation system comprising:
a process model specific for at least a portion of the paper production process; and
material portion representors being virtual representations in the process model of material portions within the continuous flow of material being processed, each of the material portion representors comprising at least one quality attribute for the respective material portion,
the quality estimation system being configured for:
receiving a stream of measured quantities of the material being processed determined by a sensor;
associating respective time stamps with the measured quantities;
determining, for each of the measured quantities and using the associated time stamps, respectively:
(iii) an associated material portion of the material portions, and
(iv) an associated position within the associated material portion;
determining, for a selected material portion of the material portions, the at least one quality attribute based on the measured quantities to which the selected material portion is associated and on the associated position within the selected material portion); and
outputting the determined at least one quality attribute.
